(19) United States
(12) Patent Application Publication
(10) Pub. No.: US 2004/0093520 A1
(43) Pub. Date: May 13, 2004

(54) Firewall system combined with embedded hardware and general-purpose computer

(76) Inventors: Hak-Moo Lee, Seoul (KR); Suk-Won Han, Seoul (KR)

Correspondence Address: Fulbright & Jaworski, Twenty Night Floor, 865 South Figueroa, Los Angeles, CA, 90017-2571, US

(21) Appl. No.: 10/312,973

(22) PCT Filed: Jul. 3, 2001
(86) PCT No.: PCT/KR01/01133

(30) Foreign Application Priority Data
Jul. 3, 2000 (KR) 2000/37622

(51) Int. Cl. G06F 11/30

(52) U.S. Cl. 713/201

(57) ABSTRACT

Embedded hardware of the present invention is optimized to perform packet or cell filter function by receiving packet or cell from the external and internal network, network address conversion function, and access control function and TCP connecting control function. A general-purpose computer coupled with the embedded hardware via the PCI interface executes various functions as a firewall of certification etc. for user under the general Windows operation system as an application program.

In accordance with the present invention, packet or cell filter function, etc. which is the essential function of the firewall adopts to copes with the speed of the network communication becoming more and more fast with high speed process in the embedded hardware, and to carry out various functions corresponding to the standards approved by the government so that expansion of functions and diversity can be obtained.

### FIELD OF THE INVENTION

The present invention relates to a firewall system for blocking intrusion on networks, and more particularly to a firewall system that is configured in combination with an embedded hardware and a general-purpose computer and provides more efficient and high-speed performance.

### DESCRIPTION OF THE RELATED ART

A firewall, which is directed to averting unauthorized network intrusions from the external or internal network on the Internet, is located at the connection point between the networks and carries out the role of controlling and supervising all network connections passing through the network.

FIG. 1 is a view of the network constitution of a general firewall system.

In general, firewall 40 is installed among internal network 10, external network 20, DMZ network 30, and intrusion detecting system 60 and processes a packet or cell passing through between the networks to control access thereof. Firewall 40 and external network 20 are connected through router 50, and web server 70 and mail server 80 are connected to DMZ network 30. DMZ network 30 exists to provide opened service for external network 20 in the internal network 10. Further, intrusion detecting system 60 carries out the function of detecting the action of a user who has accessed the networks and, according to the user's action, determining whether the user is a hacker with the object of intrusion, and is linked together with firewall 40 carrying out the function of blocking intrusion.

Such conventional firewall system could be divided into two forms.

The first conventional firewall system is embodied as an exclusive hardware. In other words, the first conventional firewall system is the exclusive hardware that comprises a CPU, which is designed to carry out the function only as a firewall, a memory, a network interface and the like.

Meanwhile, the second conventional firewall system is embodied as a Windows operating system-based general-purpose computer. That is, a program executing the function of firewall is stored in the memory of such general-purpose computer, which enables CPU to carry out the function.

Such first and second conventional firewall systems have their respective problem.

The first conventional firewall system embodied as the exclusive hardware, although advantageously it is designed to quicken a specific operation thus its high-speed processing is possible, is limited to its expansion to have a variety of functions because it is an exclusive hardware. Moreover, the firewall system comprising exclusive hardware only has difficulty in observing the evaluation grade approved by the government. Besides, disadvantageously, it is difficult for a person having no related technical knowledge to embody such firewall system of exclusive hardware.

Advantageously, the second conventional firewall system embodied as the general-purpose computer provides users with a variety of functions of the firewall system and is easily operated even by a person having no related technical knowledge. However, because such general-purpose computer is not optimally designed to process the specific function of firewall, there is restriction to its processing speed no matter how performance of CPU improves. In particular, the required processing amount and processing speed of firewall will be increased as time goes on to the future, which can not be satisfied as for a general-purpose computer.

### SUMMARY OF THE INVENTION

The present invention, which is directed to overcoming the problem of prior art as described above, provides a firewall system in combination with the advantage of exclusive hardware and that of general-purpose computer. In other words, a packet or cell filter function and the like, the indispensable function of firewall requiring the high-speed processing, is rapidly processed in the exclusive hardware in advance, and a variety of functions corresponding to the standard approved by the government can be processed in the general-purpose computer.

In order to achieve the above object, the present invention provides a firewall system for averting unauthorized network intrusions from the external or internal network that comprises an embedded hardware being designed to receive a packet or cell from the external or internal network and carry out the first functions as a firewall and a general-purpose computer being connected to embedded hardware, and being programmed to carry out the second functions different from the first functions as a firewall.

In this connection, the first functions carried out by the embedded hardware comprise a packet or cell filter function of receiving a packet or cell from the external or internal network and selectively delivering or blocking said packet or cell between the networks, a network address conversion function of newly defining IP address of the internal network, an access control function of restricting access of a packet or cell between the networks, and a TCP connecting management function of maintaining a connection by TCP protocol between the networks.

Further, the second function carried out by the general-purpose computer comprises a user authentication function of identifying and authenticating identity of a user who attempts access. And, it is desirable that the embedded hardware and the general-purpose computer are connected each other via PCI interface.

In order to achieve the above another purpose, the present invention provides a firewall system for averting unauthorized network intrusions from the external or internal network that comprises a general-purpose computer receiving a packet or cell from the external or internal network and an embedded hardware being connected the general-purpose computer, and being designed to carry out the first functions as a firewall wherein the general-purpose computer being programmed to carry out the second functions different from the first function as a firewall.

In this connection, the first functions carried out by the embedded hardware comprise a packet or cell filter function of selectively delivering or blocking a packet or cell between the networks, a network address translation function of newly defining IP address of the internal network, an access control function of restricting access of a packet or cell between the networks, and a TCP connecting management function of maintaining a connection to TCP protocol between the networks.

Additionally, the second function carried out by the general-purpose computer comprises a user authentication function of identifying and authenticating identity of a user who attempts access. And, it is desirable that the embedded hardware and the general-purpose computer are connected each other via PCI interface.

### BRIEF DESCRIPTION OF THE DRAWINGS

FIG. 1 is a view of the network constitution of a general firewall system.

FIG. 2 is a block view representing the constitution of the embedded hardware in accordance with the first preferred embodiment of the present invention.

FIG. 3 is a block view representing the constitution of the firewall system in accordance with the first preferred embodiment of the present invention.

FIG. 4 is a block view representing the constitution of the firewall system in accordance with the second preferred embodiment of the present invention.

### DETAILED DESCRIPTION OF THE PREFERRED EMBODIMENTS

Hereinbelow, the preferred embodiments of the present invention are specifically explained referring to the drawings attached hereto.

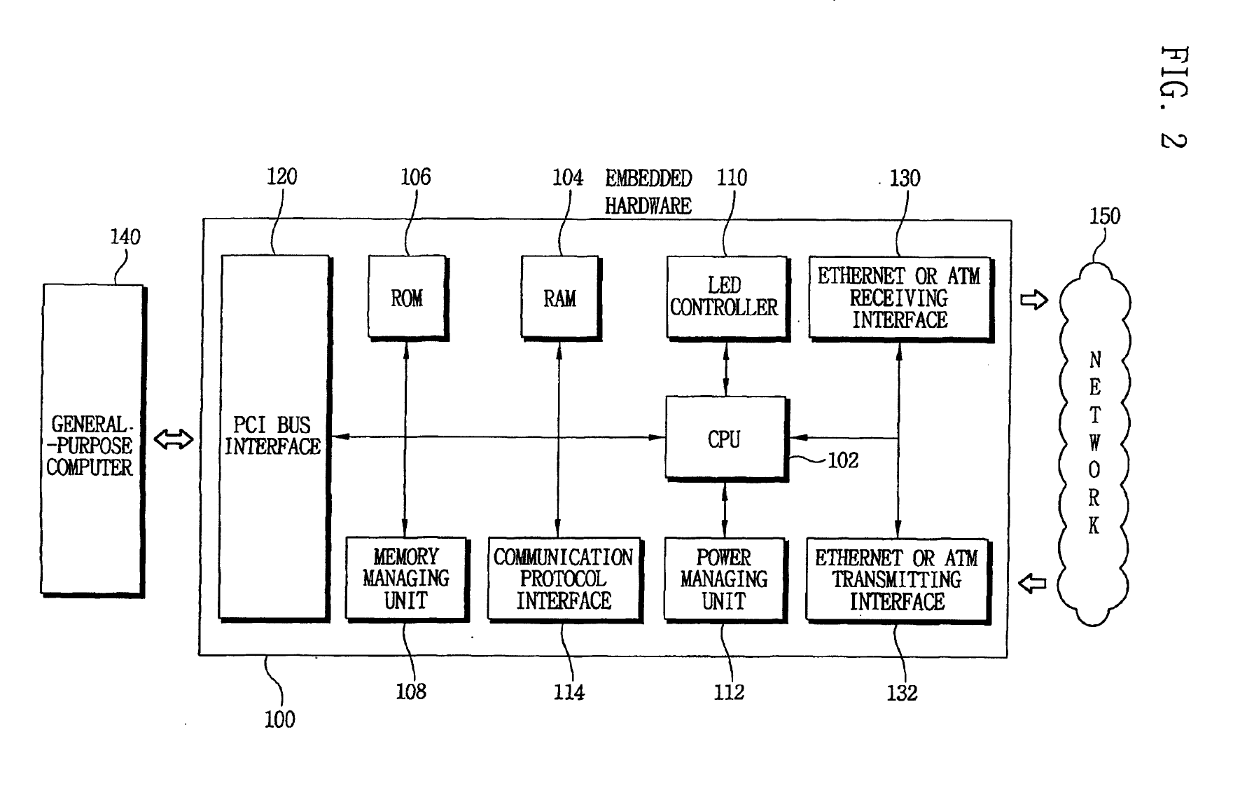

FIG. 2 is a block view representing the constitution of the embedded hardware in accordance with the first preferred embodiment of the present invention. Herein, the embedded hardware indicates the exclusive hardware optimally designed to carry out the specific function only of a firewall at high speed.

Embedded hardware 100 comprises CPU 102, RAM 104, ROM 106, memory managing unit 108, LED controller 110, power managing unit 112, communication protocol interface 114, PCI bus interface 120, ethernet or ATM receiving interface 130, and ethernet or ATM transmitting interface 132.

CPU 102 carries out an operation requiring the high-speed processing based on simple algorithm which is indispensable in the functions of a firewall system and controls all operations of embedded hardware 100. As such, most of the simple operations are processed in CPU thereby hardly affecting the resource of the entire hardware system.

ROM 106 stores algorithm indispensable to the firewall system, the environment value set by an operator and the list generated itself. Such algorithm, environment value, and list are employed for the quick access-processing to CPU 102.

PCI bus interface 120 is mounted on the PCI slot of general-purpose computer 140 and, when operated, plays the role of an interface of embedded hardware 100 and general-purpose computer 140 so that both can complement the intrusion blocking function each other. Such PCI bus interface 120 can be easily installed in the established computer system and thus used without any alterations in the constitution of hardware.

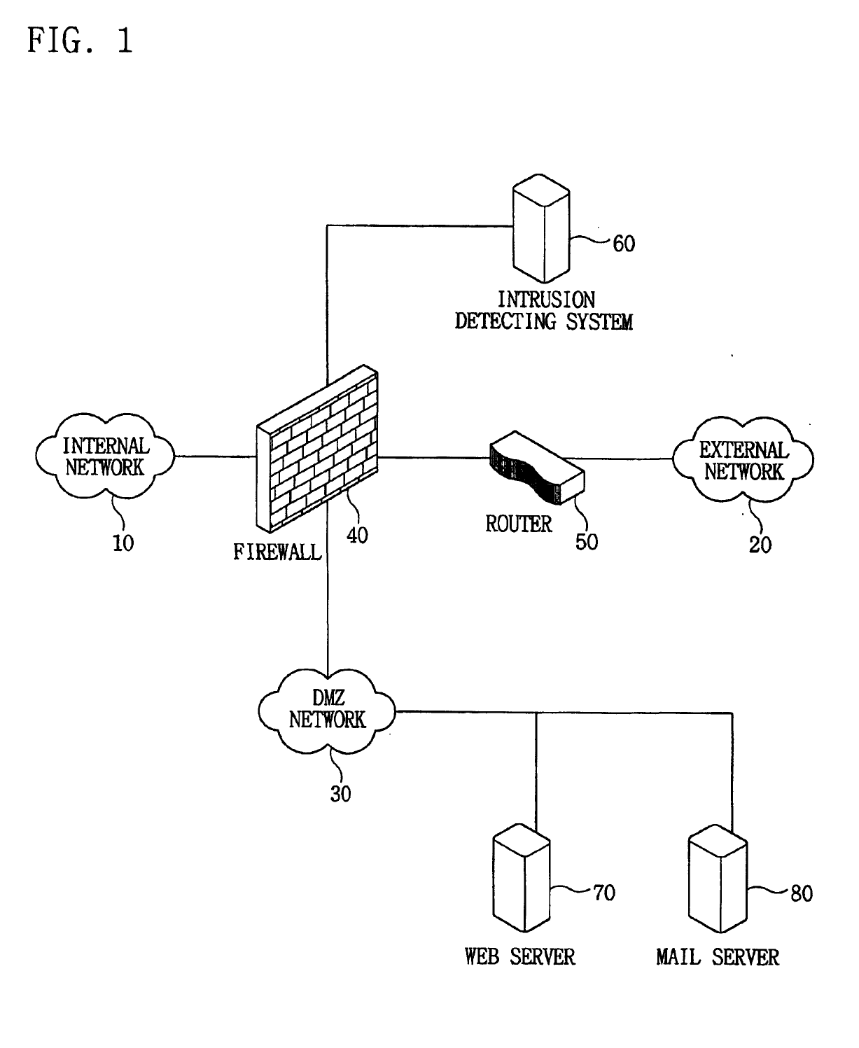

Ethernet or ATM transmitting/receiving interface 130 and 132 is the interface with internal network 10, external network 20, DMZ network 30, and intrusion detecting system 60 in FIG. 1, which enables an ethernet packet or ATM cell to be transmitted between the networks 150.

Communication protocol interface 114 plays the role of communications between the Widows operating system-based application program of general-purpose computer 120 and the operating system of embedded hardware 100. In case a user should change the environment value by using an application program and deliver a certain value to the application program in the embedded hardware 100, it communicates and enables the two systems to be linked together.

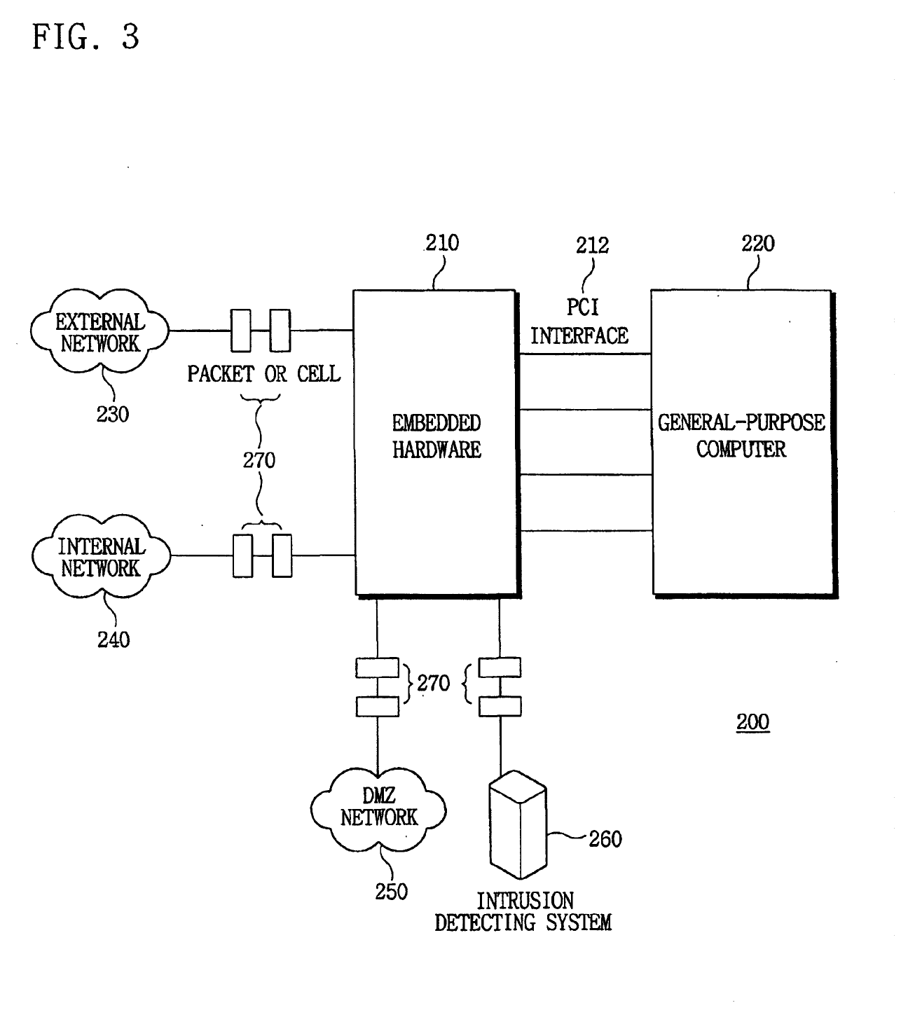

As described above, embedded hardware 100 is optimally designed to carry out only the special and indispensable function (will be explained later in FIG. 3) in a firewall thereby providing the function of high-speed and high-performance. Further, embedded hardware 100 carrying out the above function can not have necessarily the same constitution as that of FIG. 2. And it is obvious to those skilled in the pertinent art that it makes various means of embodiment possible, for instance, an embodiment of one integrated chip.

FIG. 3 is a block view representing the constitution of the firewall system in accordance with the first preferred embodiment of the present invention.

Firewall system 200 in accordance with the first preferred embodiment of the present invention comprises embedded hardware 210 transmitting/receiving a packet or cell 270, which is networked with external network 230, internal network 240, DMZ network 250, and intrusion detecting system 260, and general-purpose computer 220 with which embedded hardware 210 is connected via PCI interface 212.

In this regard, embedded hardware 210 is connected with the networks via ethernet or ATM transmitting/receiving interface, whereas general-purpose computer 220 is not directly connected with the networks. Embedded hardware 210 and general-purpose computer 220 are connected via PCI interface 212, AGP or USB interface.

Hereinbelow, their respective function carried out as a firewall in the embedded hardware 210 and the general-purpose computer 220 of firewall system 200 in accordance with the first preferred embodiment of the present invention is separately explained.

There are four functions carried out by the embedded hardware (210) that includes: (a) a packet or cell filter function wherein a packet or cell delivered between the networks is received and the required information is obtained therefrom thereby selectively delivering or blocking the packet or cell between the networks; (b) an access control function of restricting access under the rules based on the access control list of a packet or cell between the networks; (c) a TCP connecting management function of maintaining a connection when connected by using a TCP protocol between the networks; and (d) a network address translation function of newly defining and employing IP address of the internal network thereby completely blocking access from the external network to the internal network and settling shortage of IP address.

The above functions carried by such embedded hardware 210 should be processed most frequently and at high speed in the functions carried out as a firewall, which is the most core portion in view of the performance such as the processing speed of firewall and the like. The present invention carries out such frequent and indispensable function in the optimized exclusive hardware, embedded hardware 210, thereby having a superior performance to the conventional firewall system.

Next, there are probably a variety of functions carried out by general-purpose computer 220 as a firewall that includes, for example, but not limited to: (a) a user authentication function of identifying and authenticating identity of a user who attempts access to the host of an internal or external network; (b) an administrator alert function wherein in case an intrusion into network occurs, such is rapidly notified to a network security administrator; (c) a traffic statistic function of analyzing a packet or cell delivered between the networks by time, type of protocol, type of access and the like; (d) a data integrity function wherein in case an unauthorized user's illegal alteration other than an authorized administrator's normal alteration for the security function-related data occurs, such is perceived and notified to the administrator; (e) an audit recording function of recording security-related activities in light of the information protection system and analyzing the recorded material thereby preventing intrusions and tracking illegal actions; and (f) a user interface function of enabling an operator to install firewall, set and alter the environment value, check the audit recording and the like.

The means carrying out the above function as a firewall is stored in the form of an application program in Windows operating system-based general-purpose computer 220. In this connection, the functions as a firewall suggested for example are not necessarily indispensable, but comply with the evaluation grade approved by the government, and meet a variety of requirements of the operator.

Therefore, the above functions are not necessarily carried out all the time, and embedded hardware 210 only can be worked according to the operator's decision at the time of operating the firewall system. And, the above functions are processed by using the Windows operating system-based application program familiar to the operator and widely known so that it is easy even for a person having no related technical knowledge to embody and operate the firewall system having a variety of functions as above.

A firewall system in accordance with the second preferred embodiment of the present invention, that is similar in the object and effect to be accomplished but somewhat different in the constitution compared to the first preferred embodiment of the present invention, is explained.

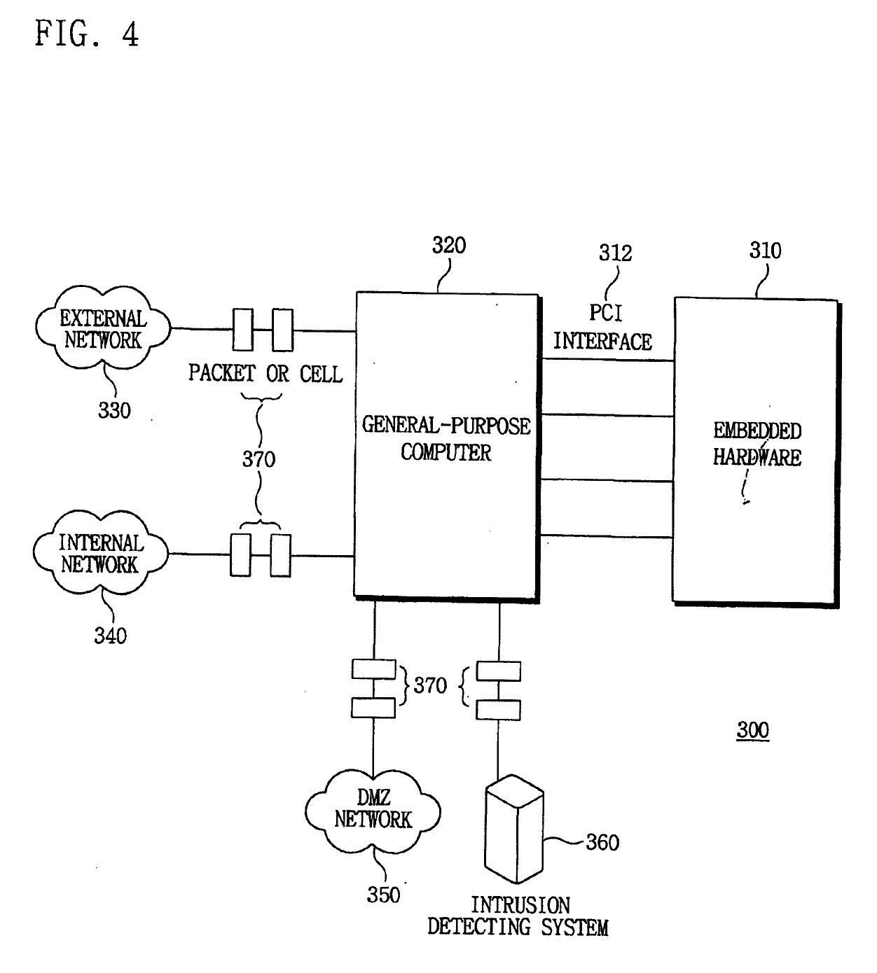

FIG. 4 is a block view representing the constitution of the firewall system in accordance with the second preferred embodiment of the present invention.

Firewall system 300 in accordance with the second preferred embodiment of the present invention comprises general-purpose computer 320 transmitting/receiving a packet or cell 370, which is networked with external network 330, internal network 340, DMZ network 350, and intrusion detecting system 360, and embedded hardware 310 with which the general-purpose computer 320 is connected via PCI interface 312.

Compared to the firewall system 200 of the first preferred embodiment, it is different that the general-purpose computer is responsible for receiving a packet or cell from the networks in the firewall system of the second preferred embodiment. In other words, general-purpose computer 320 is connected with the networks via ethernet or ATM transmitting/receiving interface, whereas embedded hardware 310 is not directly connected with the networks. Thus, embedded hardware 310 of the second preferred embodiment of the present invention does not have ethernet or ATM transmitting/receiving interface 130 and 132 inside the hardware differently from embedded hardware 100 shown in FIG. 2. Further, embedded hardware 310 is mounted on the PCI slot of general-purpose computer 320.

Such firewall system 300 in accordance with the second preferred embodiment is different from firewall system 200 in accordance with the first preferred embodiment in the constituent receiving a packet or cell from the networks. However, the function general-purpose computer 320 and embedded hardware 310 of the second preferred embodiment carry out as a firewall is the same as that of the general-purpose computer 220 and embedded hardware 210 of the first preferred embodiment. In the firewall system 300 in accordance with the second preferred embodiment, therefore, embedded hardware 310 is in charge of function requiring the frequent and high-speed processing and general-purpose computer 320 of a variety of functions other than that function.

The present invention is specially illustrated and described referring to the above preferred embodiments, however, which are employed for example and can be understood by those skilled in the art to which the present invention pertains that various modifications are possible within the spirits and scope of the present invention as defined in the claims appended hereto.

### Industrial Applicability

As aforementioned above, the present invention processes a packet or cell filter function and the like, the indispensable function of a firewall, at high speed in the embedded hardware thereby adapting to the network communication speed which has been getting faster, and a variety of functions corresponding to the standard approved by the government in the general-purpose computer thereby obtaining an expansion and diversity of the function.

In addition, the embedded hardware of high-performance and the Windows operating system-based application program interface providing a variety of functions are able to contribute to the popularization of security equipment of which use is limited to the special field.

What is claimed is:

1. A firewall system for averting unauthorized network intrusions from the external and internal network, comprising:
an embedded hardware being designed to receive a packet or cell from said external and internal network and carry out a first function as a firewall; and
a general-purpose computer being connected to said embedded hardware, and being programmed to carry out a second function different from said first function as a firewall.

2. The firewall system according to claim 1, wherein said first function carried out by said embedded hardware comprises:
a packet or cell filter function of receiving a packet or cell from said external and internal network and selectively delivering or blocking said packet or cell between the networks;
a network address translation function of newly defining IP address of the internal network;
an access control function of restricting access of a packet or cell between the networks; and
a TCP connecting management function of maintaining a connection by TCP protocol between the networks.

3. The firewall system according to claim 1, wherein said second function carried out by said general-purpose computer comprises a user authentication function of identifying and authenticating identity of a user who attempts access.

4. The firewall system according to any one of claim 1 to claim 3, wherein said embedded hardware and said general-purpose computer are connected each other via PCI interface.

5. A firewall system for averting unauthorized network intrusions from the external and internal network, comprising:
a general-purpose computer receiving a packet or cell from said external and internal network; and
an embedded hardware being connected to said general-purpose computer, and being designed to carry out a first function as a firewall,
wherein said general-purpose computer being programmed to carry out a second function different from said first function as a firewall.

6. The firewall system according to claim 5, wherein said first function carried out by said embedded hardware comprises:
a packet or cell filter function of selectively delivering or blocking said packet or cell between the networks;
a network address translation function of newly defining IP address of the internal network;
an access control function of restricting access of a packet or cell between the networks; and
a TCP connecting management function of maintaining a connection to TCP protocol between the networks.

7. The firewall system according to claim 5, wherein said second function stored in said general-purpose computer comprises a user authentication function of identifying and authenticating identity of a user who attempts access.

8. The firewall system according to any one of claim 5 to claim 7, wherein said embedded hardware and said general-purpose computer are connected each other via PCI interface.
